(19) United States
(12) Patent Application Publication
(10) Pub. No.: US 2008/0013998 A1
(43) Pub. Date: Jan. 17, 2008

(54) Powder transport unit having enhanced transportability and operability, process cartridge and image forming apparatus using the same

(76) Inventors: Naohiro Kumagai, Machida city (JP); Masato Yanagida, Meguro-ku (JP); Shuji Tanaka, Chigasaki city (JP); Takatsugu Fujishiro, Taito-ku (JP); Hiroomi Harada, Kawasaki city (JP); Takeshi Tabuchi, Sagamihara city (JP); Tokuya Ojimi, Kawasaki city (JP); Chohtaroh Kataoka, Kawasaki city (JP); Takaaki Tawada, Yokohama city (JP); Shinichi Kawahara, Setagaya-ku (JP); Haruji Mizuishi, Ota-ku (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/528,635

(22) Filed: Sep. 28, 2006

(30) Foreign Application Priority Data
Sep. 28, 2005 (JP) JP 2005-281951
Sep. 28, 2005 (JP) JP 2005-281105

(51) Int. Cl. G03G 21/00

(52) U.S. Cl. 399/358

(57) ABSTRACT

A powder transport unit for transporting powders includes a transport pipe, a powder transport member, and a regulating member. The transport pipe is curvingly extended. The powder transport member is disposed in an entire length of the transport pipe and rotates in the transport pipe to transport the powders. The regulating member is integrally formed with the transport pipe at a downstream end of the transport pipe, and regulates a length of the powder transport member disposed in the entire length of the transport pipe. The regulating member includes an exit hole to pass through the powders transported by the powder transport member in the transport pipe.

### CROSS REFERENCE TO RELATED APPLICATIONS

This application claims priority from Japanese patent applications No. 2005-281105 and No. 2005-281951 each filed on Sep. 28, 2005 in the Japan Patent Office, the entire contents of which are hereby incorporated by reference herein.

### FIELD OF INVENTION

The present disclosure relates to an image forming apparatus using electrophotography, and more particularly to a powder transport unit for transporting powders, such as toner particles, in an image forming apparatus, and a process cartridge for use in an image forming apparatus having such powder transport unit.

### DESCRIPTION OF RELATED ART

In related art image forming apparatus using electrophotography, a cleaning unit removes toner particles remaining on a photosensitive member or an intermediate transfer member after transferring a toner image on a recording medium. Then a decharger decharges a surface of the photosensitive member or intermediate transfer member to prepare for a next image forming.

Toner particles recovered by the cleaning unit can be transported by a transport unit to a waste toner tank for collecting toner particles or to a developing unit for re-using toner particles, for example.

Such a transport unit may include a transport pipe and a powder transport member, which is rotatable in the transport pipe.

In such a transport unit, toner particles can be transported in an axial direction of the transport pipe by rotating the powder transport member in the transport pipe.

Such a powder transport member may include a screw type, a helical coil type, for example, and may include a helical coil type having no core shaft when considering manufacturing cost.

For example, a transport unit may include a first transport pipe and a second transport pipe connected to each other. The first transport pipe includes a first powder transport member of helical coil type and the second transport pipe includes a second powder transport member of helical coil type.

In such a configuration, toner particles recovered by a cleaning unit can be transported to a waste toner tank or developing unit via the first transport pipe and second transport pipe. Toner particles can be transported by the first powder transport member and second powder transport member.

Such a powder transport member of helical coil type having no core shaft may be preferable from a viewpoint of manufacturing cost as above-mentioned.

However, such a powder transport member may have a variation in its length, which may occur mainly by two factors of manufacturing process and installation condition.

A transport member shaped in a helical coil has no shaft in its center portion. Such a helical-shaped transport member may elongate and contract in a longitudinal direction of the transport member with a greater degree compared to a transport member having a shaft in its center portion.

For example, if a helical-shaped transport member is hanged in a vertical direction, the helical-shaped transport member elongates in a vertical direction due to its own weight.

Compared to a helical-shaped transport member having a cross-sectional area of circular shape, a helical-shaped transport member having a cross-sectional area of rectangular shape may more easily elongate in the longitudinal direction of the helical-shaped transport member.

Because the helical-shaped transport member easily elongates in a vertical direction as mentioned above, a length of the helical-shaped transport member is measured by placing the helical-shaped transport member on a horizontal face.

In general, when manufacturing such a helical-shaped transport member, a tolerance of about 2% of total length of the transport member is required. Although a further smaller tolerance may be used to manufacture a helical-shaped transport member more precisely, a manufacturing yield and a manufacturing cost of the helical-shaped transport member may become unfavorably degraded if such further smaller tolerance is pursued.

Furthermore, such a helical-shaped transport member may elongate in a longitudinal direction with a smaller force. Specifically, when the helical-shaped transport member is inserted in a curved-shape housing, the helical-shaped transport member may contact with an inner surface of the curved-shape housing, and such contacting condition may not be controlled precisely. Accordingly, an elongation level of the helical-shaped transport member may not be precisely controlled.

For example, if a length of the helical-shaped transport member becomes too short, a downstream end of the helical-shaped transport member may not reach a pipe exit of the first transport pipe. If a length of the helical-shaped transport member becomes too long, a downstream end of the helical-shaped transport member may protrude from a pipe exit of first transport pipe.

If the downstream end of the helical-shaped transport member may not reach the pipe exit of the first transport pipe, for example, toner particle transportability after the downstream end of the helical-shaped transport member may degrade, and toner particle clogging may occur at a connection of the first transport pipe and second transport pipe, for example.

If a downstream end of the helical-shaped transport member may protrude from the pipe exit of the first transport pipe, for example, the helical-shaped transport member may interfere with the second transport pipe or a helical transport member in the second transport pipe, by which an interference may occur when assembling the first transport pipe and transport second pipe.

Furthermore, if the pipe exit is connected to a waste toner tank or a shutter, a downstream end of the helical-shaped transport member may interfere with the waste toner tank or shutter.

Furthermore, in an image forming apparatus using electrophotography, maintenance work, such as replacement, repair, and routine check, may be conducted by opening an outer cover of the image forming apparatus, and components or units may be removed from the image forming apparatus when conducting such maintenance work.

For example, a process cartridge may be removed from the image forming apparatus for maintenance work, and then a cleaning unit may be further removed from the process cartridge.

When a user removes the cleaning unit from the image forming apparatus for maintenance work, the user may place the cleaning unit on a floor face, for example.

At such time, an exit mouth of the cleaning unit may be exposed to the atmosphere. A user may touch the exit mouth, by which the user's hand or clothing may be stained.

In addition, such a cleaning unit may be laid on the floor face with little space therebetween during maintenance work. Therefore, the user may feel inconvenienced to pick up the cleaning unit from the floor face when installing the cleaning unit again into the image forming apparatus after the maintenance work. Therefore, such a cleaning unit may not be preferable for a efficient maintenance work for the image forming apparatus.

### SUMMARY

The present disclosure relates to a powder transport unit for transporting powders including a transport pipe, a powder transport member, and a regulating member. The transport pipe is curvingly extended. The powder transport member is disposed in an entire length of the transport pipe and rotates in the transport pipe to transport the powders. The regulating member is integrally formed with the transport pipe at a downstream end of the transport pipe, and regulates a length of the powder transport member disposed in the entire length of the transport pipe. The regulating member includes an exit hole to pass through the powders transported by the powder transport member in the transport pipe.

The present disclosure also relates to a process cartridge for use in an image forming apparatus. The process cartridge includes a photosensitive member, a cleaning unit, and a powder transport unit. The photosensitive member forms a latent image thereon to be developed as a toner image by toner particles. The cleaning unit removes the toner particles remaining on the photosensitive member. The cleaning unit includes a powder container to collect the toner particles removed from the photosensitive member. The powder transport unit transports the removed toner particles. The powder transport unit includes a transport pipe, a powder transport member, and a regulating member. The transport pipe is curvingly extended and connected to the powder container. The powder transport member is disposed in an entire length of the transport pipe and the powder container, and rotates in the transport pipe and the powder container to transport the removed toner particles. The regulating member is integrally formed with the transport pipe at a downstream end of the transport pipe, and regulates a length of the powder transport member disposed in the entire length of the transport pipe. The regulating member includes an exit hole to pass through the removed toner particles transported by the powder transport member in the transport pipe.

The present disclosure also relates to an image forming apparatus. The image forming apparatus includes a photosensitive member, a cleaning unit, and a powder transport unit. The photosensitive member forms a latent image thereon to be developed as a toner image by toner particles. The cleaning unit removes the toner particles remaining on the photosensitive member. The cleaning unit includes a powder container to collect the toner particles removed from the photosensitive member. The powder transport unit transports the removed toner particles. The powder transport unit includes a transport pipe, a powder transport member, and a regulating member. The transport pipe is curvingly extended and connected to the powder container. The powder transport member is disposed in an entire length of the transport pipe and the powder container, and rotates in the transport pipe and the powder container to transport the removed toner particles. The regulating member is integrally formed with the transport pipe at a downstream end of the transport pipe, and regulates a length of the powder transport member disposed in the entire length of the transport pipe. The regulating member includes an exit hole to pass through the removed toner particles transported by the powder transport member in the transport pipe.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic view of an image forming apparatus;

FIG. 2 is a schematic cross-sectional side view of a process cartridge used in an image forming apparatus in FIG. 1;

FIG. 3 is a perspective view of a process cartridge used in an image forming apparatus in FIG. 1;

FIG. 4 is another schematic cross-sectional side view of a process cartridge used in an image forming apparatus in FIG. 1;

FIG. 5 is a perspective view of a process cartridge in FIG. 3, in which a developing unit is removed;

FIG. 6 is a perspective view of a process cartridge in FIG. 3, in which a developing unit and a photosensitive unit are removed;

FIG. 7 is an expanded view of one end side of process cartridge shown in FIG. 6;

FIG. 8 is a perspective view of a cleaning unit included in a process cartridge in FIG. 3;

FIG. 9 is a cross-sectional view of a powder transport unit attached to a cleaning unit in FIG. 8;

FIG. 10 is an expanded view of powder transport coil used for transporting powders;

FIG. 11A is a perspective view of a coil shaft wound with a powder transport coil, in which a drive gear is attached to a coil shaft;

FIG. 11B is a perspective view of a coil shaft wound with a powder transport coil, in which a drive gear is removed from a coil shaft;

FIG. 12 is a side view of a coil shaft wound with a powder transport coil, in which a step is provided on a coil shaft;

FIG. 13 is a schematic view explaining a length relationship of a powder transport coil and a powder transport unit;

FIG. 14 is an expanded view of a boundary portion of a cleaning unit and a powder transport unit;

FIG. 15 is an expanded view of an free edge of powder transport coil; and

FIG. 16 is a perspective view of a cleaning unit and a powder transport unit placed on a plane.

### DETAILED DESCRIPTION OF EXAMPLE EMBODIMENTS

In describing example embodiments shown in the drawings, specific terminology is employed for the sake of clarity. However, the disclosure of this present invention is not intended to be limited to the specific terminology so selected and it is to be understood that each specific element includes all technical equivalents that operate in a similar manner.

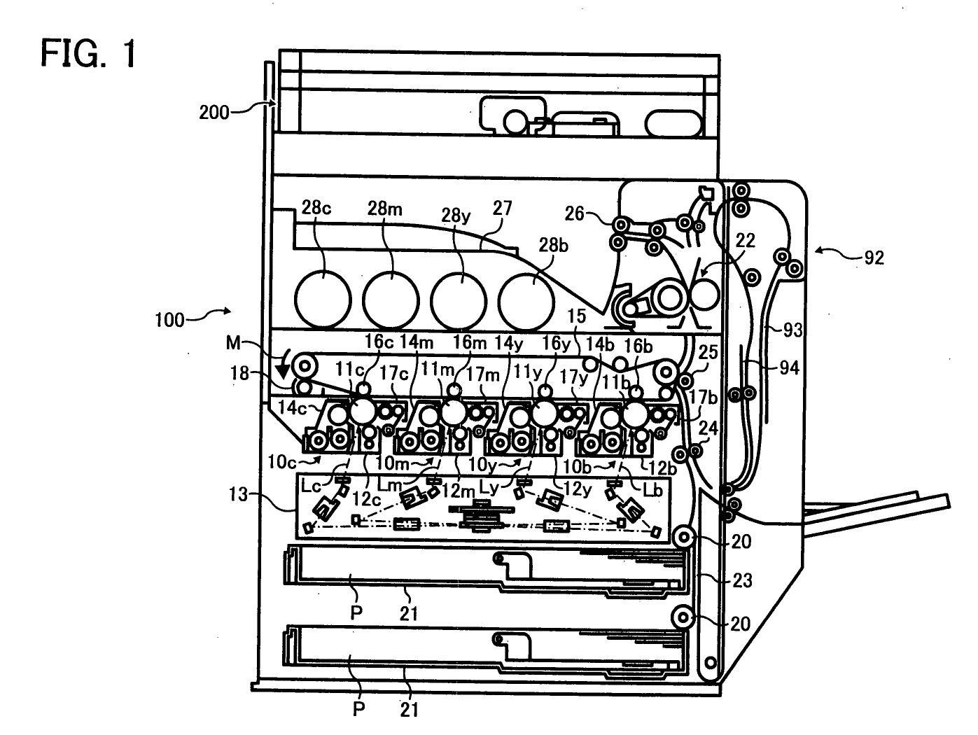

Referring now to the drawings, wherein like reference numerals designate identical or corresponding parts throughout the several views, an image forming apparatus according to an example embodiment is described with particular reference to FIG. 1.

FIG. 1 is a schematic view of an image forming apparatus 100, such as a color image forming apparatus of tandem type.

The image forming apparatus 100 may include a scanning unit 200 over the image forming apparatus 100 as shown in FIG. 1.

As shown in FIG. 1, the image forming apparatus 100 includes four image forming units 10c, 10m, 10y, and 10b, a writing unit 13, an intermediate transfer belt 15, a fixing unit 22, for example.

The four image forming units 10c, 10m, 10y, and 10b, can be arranged in a tandem manner for forming cyan, magenta, yellow, and black image in the image forming units 10c, 10m, 10y, and 10b.

As shown in FIG. 1, the image forming unit 10c, 10m, 10y, and 10b include photosensitive units 11c, 11m, 11y, and 11b, and charging units 12c, 12m, 12y, and 12b, respectively. The photosensitive units 11c, 11m, 11y, and 11b have a drum shape as shown in FIG. 1.

When the photosensitive units 11c, 11m, 11y, and 11b rotate in a clockwise direction in FIG. 1, the charging units 12c, 12m, 12y, and 12b uniformly charges a surface of the respective photosensitive units 11c, 11m, 11y, and 11b with a bias voltage.

Then, the writing unit 13 irradiates laser beams Lc, Lm, Ly, and Lb to the respective photosensitive units 11c, 11m, 11y, and 11b based on image information scanned by the scanning unit 200 to generate an electrostatic latent image on the respective photosensitive units 11c, 11m, 11y, and 11b.

Then, developing units 14c, 14m, 14y, and 14b respectively develop the electrostatic latent image on the photosensitive units 11c, 11m, 11y, and 11b by supplying toner particles to the photosensitive units 11c, 11m, 11y, and 11b to form respective color images on the photosensitive units 11c, 11m, 11y, and 11b.

The intermediate transfer belt 15, formed into an endless-belt shape, can contact with the photosensitive units 11c, 11m, 11y, and 11b.

The intermediate transfer belt 15 can travel in a direction shown by an arrow M in FIG. 1.

As shown in FIG. 1, primary transfer units 16c, 16m, 16y, and 16b are provided for the respective photosensitive units 11c, 11m, 11y, and 11b along an inner surface of the intermediate transfer belt 15.

With an effect of the primary transfer units 16c, 16m, 16y, and 16b, each toner image of cyan, magenta, yellow, and black can be sequentially transferred onto the intermediate transfer belt 15 to form a full color toner image on the intermediate transfer belt 15.

The image forming apparatus 100 also includes a sheet feed roller 20, a sheet cassette 21, a transport route 23, and a registration roller 24 as shown in FIG. 1.

The sheet feed roller 20 is rotated to feed a recording medium P from the sheet cassette 21 to the transport route 23 at a given timing.

The recording medium P is then transported to the registration roller 24, and the recording medium P is stopped by the registration roller 24 temporarily.

The registration roller 24 is then rotated to feed the recording medium P to a secondary transfer unit 25 while synchronizing a feed timing with a traveling of the intermediate transfer belt 15 having the full color toner image.

With an effect of the secondary transfer unit 25, the full color toner image can be transferred to the recording medium P from the intermediate transfer belt 15.

Then, the recording medium P is transported to the fixing unit 22 to fix the full color toner image on the recording medium P. Then the recording medium P is ejected to a sheet stack 27 by an ejection roller 26.

After transferring the toner image from the photosensitive units 11c, 11m, 11y, and 11b to the intermediate transfer belt 15, primary cleaning units 17c, 17m, 17y, and 17b respectively remove toner particles remaining on the photosensitive units 11c, 11m, 11y, and 11b to prepare for a next image forming.

Furthermore, after transferring the toner image from the intermediate transfer belt 15 to the recording medium P, a secondary cleaning unit 18 removes toner particles remaining on the intermediate transfer belt 15 to prepare for a next image forming.

The image forming apparatus 100 also includes toner bottles 28c, 28m, 28y, and 28b. The toner bottles 28c, 28m, 28y, and 28b store respective toner particles to be supplied to the respective developing units 14c, 14m, 14y, and 14b.

The image forming apparatus 100 can record images on both faces of the recording medium P as below with a switchback unit 92 shown in FIG. 1.

The switchback unit 92 includes a switchback route 93, and a sheet feed route 94 as shown in FIG. 1.

After the fixing unit 22 fixes an image on one face of the recording medium P, the recording medium P is transported to the switchback unit 92 from the image forming apparatus 100 with an effect of a selection claw (not shown).

The recording medium P is switchbacked in the switchback route 93 to reverse faces of the recording medium P.

The recording medium P is then transported to the image forming apparatus 100 through the sheet feed route 94, and then transported to the secondary transfer unit 25 to transfer another image on another face of the recording medium P from the intermediate transfer belt 15. The recording medium P having images on both faces is then ejected to the sheet stack 27 by the ejection roller 26.

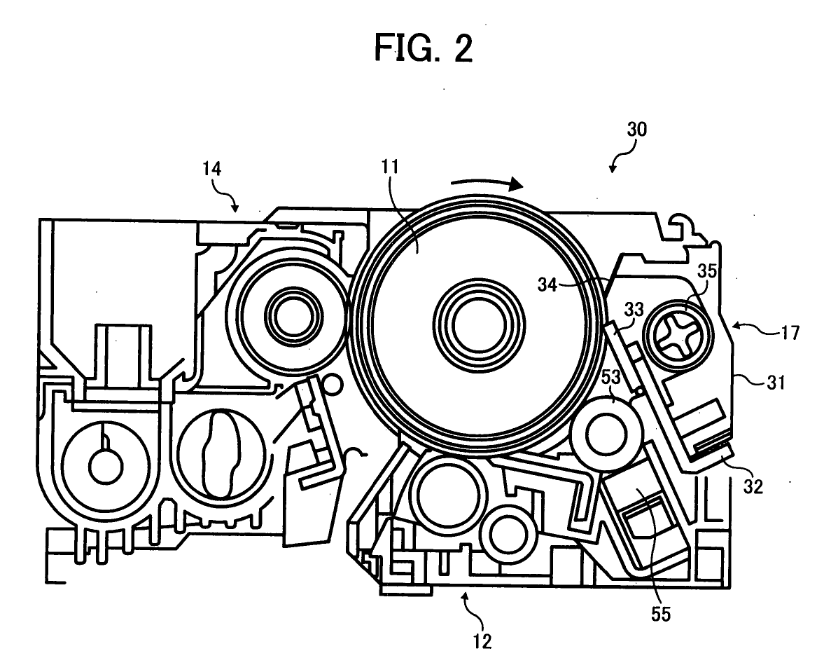

As shown in FIG. 2, a process cartridge 30 can integrate the photosensitive unit 11, charging unit 12, developing unit 14, and cleaning unit 17 in a cartridge case 31. The process cartridge 30 is designed to be detachable from the image forming apparatus 100.

The process cartridge 30 may be employed for the image forming apparatus 100 to miniaturize each component, such as photosensitive unit 11, charging unit 12, developing unit 14, and cleaning unit 17.

Furthermore, the process cartridge 30 may efficiently conduct maintenance work (e.g., repair, replacement) of each component in the process cartridge 30 because such maintenance work can be conducted by detaching the process cartridge 30 from the image forming apparatus 100.

The process cartridge 30 can be used for the image forming units 10c, 10m, 10y, and 10b similarly except a color of toner particles.

The process cartridge 30 may not need to include all kinds of components, such as photosensitive unit 11, charging unit 12, developing unit 14, and cleaning unit 17.

For example, in an example embodiment, the process cartridge 30 may include the photosensitive unit 11 and cleaning unit 17.

The process cartridge 30 may include components, such as charging unit 12, developing unit 14, and cleaning unit 17, designed as module units so that the each component can be replaced from the process cartridge 30 as one module unit, as required.

With such module units, only a module unit reaching its lifetime may need to be replaced from the process cartridge 30, by which resource waste, such as part discarding, can be reduced, for example.

As shown in FIG. 2, the cleaning unit 17 includes a blade holder 32, and a cleaning blade 33.

The blade holder 32 is attached to the cartridge case 31, and the blade holder 32 supports the cleaning blade 33. The cleaning blade 33 has an edge, which is contactable to the photosensitive unit 11.

The cartridge case 31 is also attached with a resin film 34 such as Mylar® film, wherein an edge of the resin film 34 is slightly contacted to the photosensitive unit 11 as shown in FIG. 2.

The cartridge case 31 also includes a powder transport coil 35 as powder transport member, wherein the powder transport coil 35 is rotatable.

With a rotation of the photosensitive unit 11, the cleaning blade 33 scrapes a surface of the photosensitive unit 11 to remove toner particles remaining on the photosensitive unit 11.

The resin film 34 is used to reduce the likelihood or prevent a scattering of the removed toner particles.

The removed toner particles can be collected in the cartridge case 31.

The removed toner particles are then collected on one side of the cleaning unit 17 with a rotation of the powder transport coil 35, and are ejected outside of the cartridge case 31 through a powder transport unit (to be described later).

The powder transport unit may transport such toner particles to a waste toner tank to discard the toner particles, or to the developing unit 14 to reuse the toner particles, for example.

The powder transport coil 35 may be formed in coil, screw, or helical shape, as required.

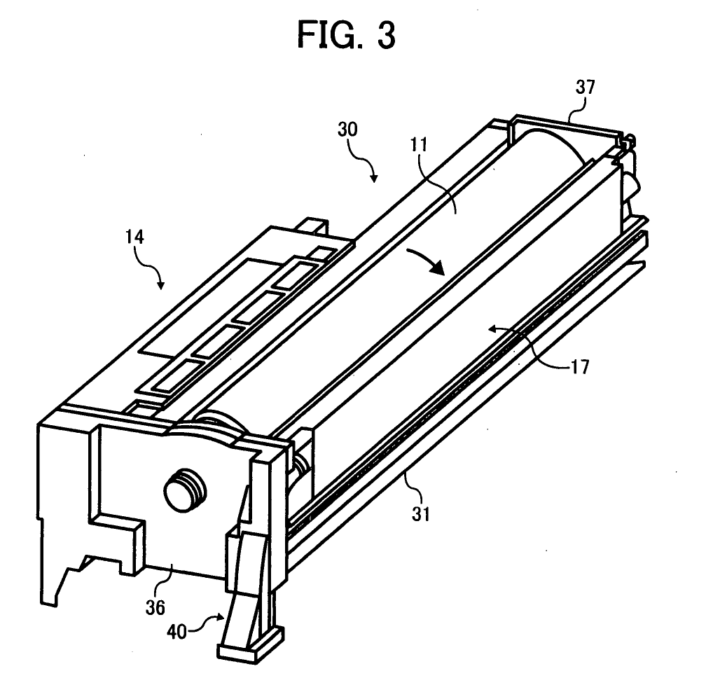

FIG. 3 is a perspective view of the process cartridge 30. The process cartridge 30 includes the photosensitive unit 11, which is rotatably supported by the cartridge case 31.

As shown in FIG. 3, the process cartridge 30 also includes the developing unit 14 and cleaning unit 17 next to the photosensitive unit 11.

As shown in FIG. 3, the cartridge case 31 includes a first plate 36 and a second plate 37 on each end of the cartridge case 31.

As shown in FIG. 3, a powder transport unit 40 is provided to the first plate 36 of the cartridge case 31, wherein the powder transport unit 40 is projected from the first plate 36.

Although not shown in FIG. 3, toner particles recovered by the cleaning unit 17 are transported in a direction from the second plate 37 toward the first plate 36 of the cartridge case 31.

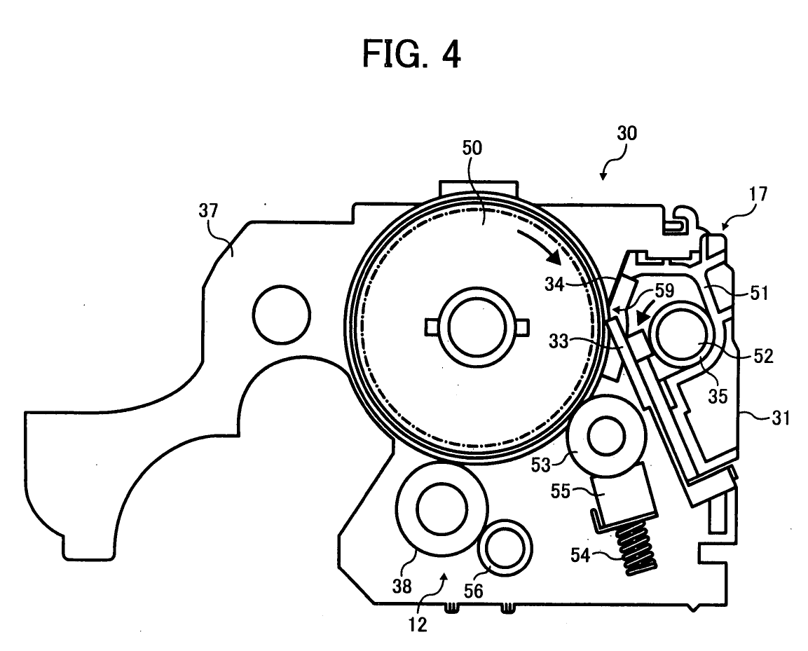

FIG. 4 is a cross-sectional side view of the process cartridge 30 at the second plate 37 side of the cartridge case 31.

As shown in FIG. 4, the process cartridge 30 includes a gear-flange 50 at the second plate 37 side of the cartridge case 31. The gear-flange 50 can rotate in a clockwise direction in FIG. 4.

As shown in FIG. 4, the cleaning unit 17 includes a powder container 51, which has a shaft 52 wound with the powder transport coil 35. The powder container 51 may extend in a longitudinal direction of the cleaning unit 17.

When the gear-flange 50 rotates in a clockwise direction in FIG. 4, the powder transport coil 35 can be rotated in a counter-clockwise direction in FIG. 4 with a configuration to be explained later.

As shown in FIG. 4, the powder container 51 has an opening 59, which faces the photosensitive unit 11. The opening 59 can be defined by the cleaning blade 33 and the resin film 34, which are contactable to the photosensitive unit 11.

Accordingly, toner particles scraped by the cleaning blade 33 can be recovered into the powder container 51 through the opening 59.

As above-mentioned, the powder container 51 may extend in a longitudinal direction of the cleaning unit 17, and includes the powder transport coil 35 therein.

Accordingly, with a rotation of the powder transport coil 35, toner particles in the powder container 51 can be transported in a longitudinal direction of the powder container 51.

As shown in FIG. 4, the process cartridge 31 includes a lubricant brush 53, a bias spring 54, and a lubricant 55 in solid state, wherein the lubricant brush 53 is provided under the cleaning blade 33.

As shown in FIG. 4, the bias spring 54 can push the lubricant 55 to the lubricant brush 53.

The lubricant brush 53 can be rotated with the photosensitive unit 11, and applies lubricant scraped from the lubricant 55 to a surface of the photosensitive unit 11. The lubricant can suppress an abrasion of the surface of photosensitive unit 11.

As shown in FIG. 4, the process cartridge 31 also includes a charge roller 38 provided in the charging unit 12. The charge roller 38 can contact the photosensitive unit 11 after the lubricant brush 53 applies lubricant to the surface of photosensitive unit 11.

As shown in FIG. 4, the charge roller 38 is contactable to a cleaning roller 56, which cleans a surface of the charge roller 38.

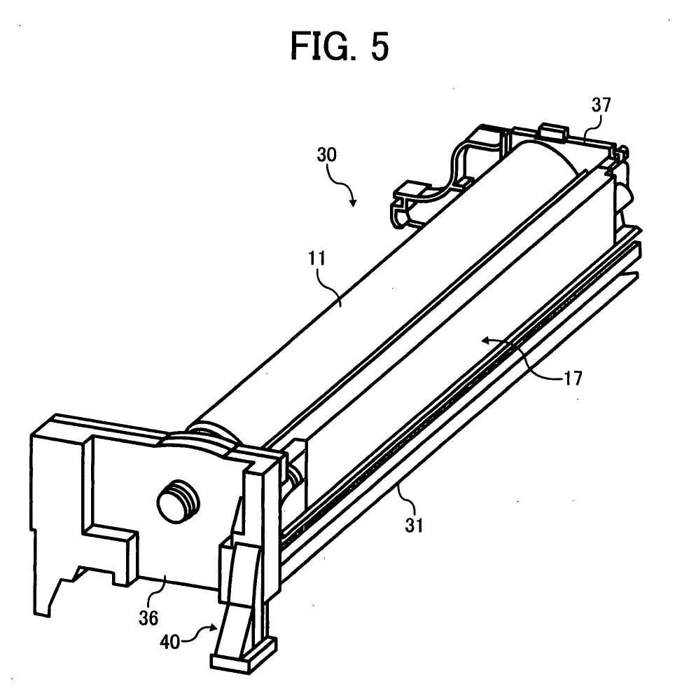

FIG. 5 is a perspective view of the process cartridge 30, in which the developing unit 14 is removed.

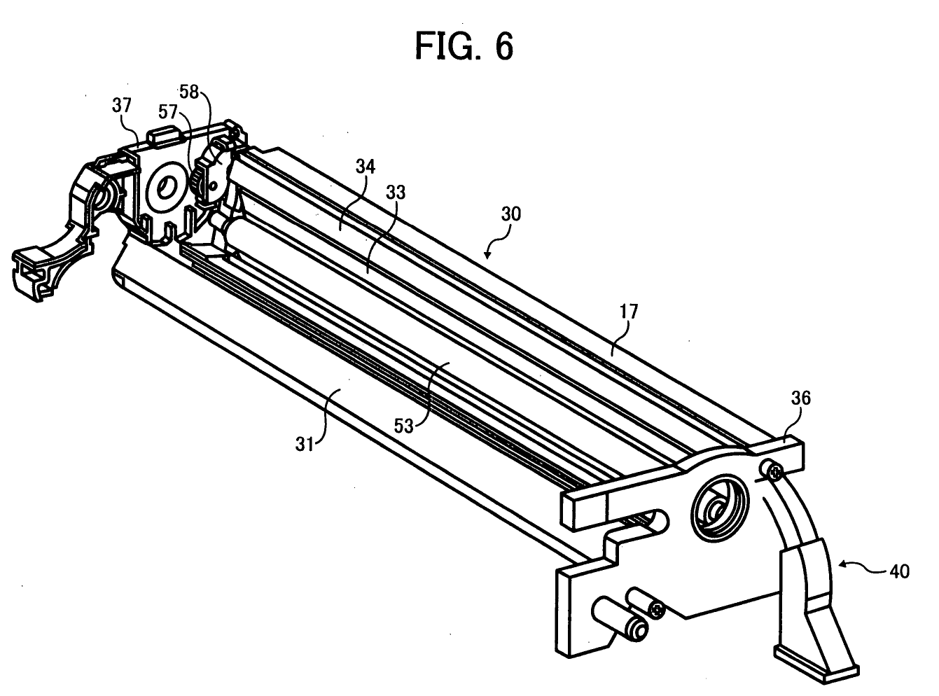

FIG. 6 is a perspective view of the process cartridge 30, in which the developing unit 14 and photosensitive unit 11 are removed.

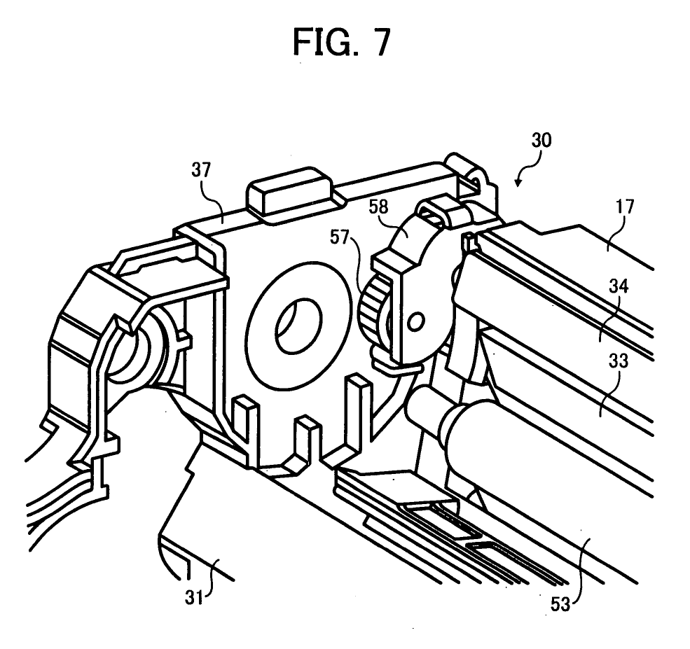

FIG. 7 is an expended view around the second plate 37 of the cartridge case 31.

As shown in FIGS. 6 and 7, the process cartridge 31 includes a first idler gear 57 and a second idler gear covered by a cover 58 (i.e., the second idler gear is not seen in FIG. 6).

The second plate 37 of the cartridge case 31 rotatably supports the first idler gear 57 and the second idler gear (not shown).

In a configuration shown in FIGS. 4 and 6, the gear-flange 50 meshes the first idler gear 57, and the first idler gear 57 meshes the second idler gear (not shown).

Furthermore, the second idler gear (not shown) can mesh with a drive gear 60 (to be described later) fixed on the shaft 52.

With such a configuration, the rotation of the gear-flange 50 can be transmitted to the drive gear 60 via the first idler gear 57 and second idler gear (not shown), and then the shaft 52 can be rotated.

Accordingly, the powder transport coil 35 wound on the shaft 52 can be rotated.

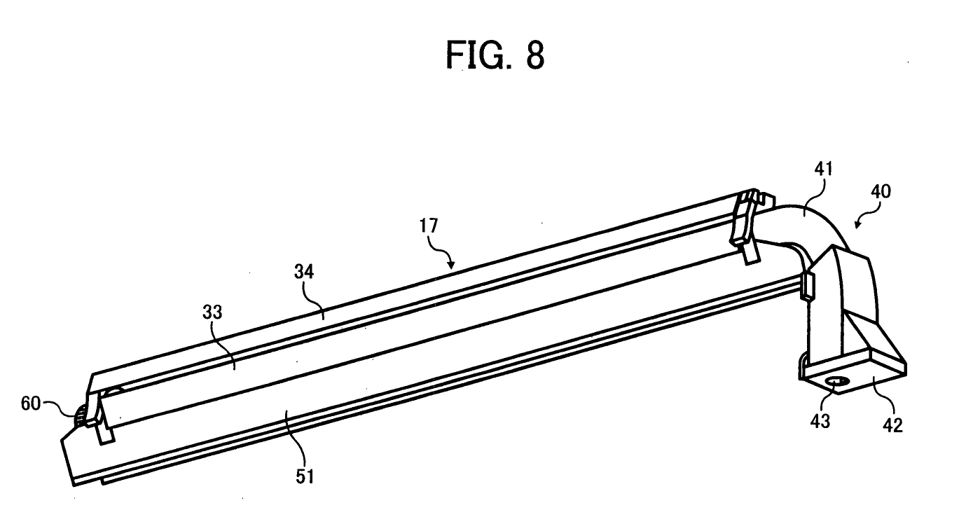

FIG. 8 is a perspective view of the cleaning unit 17 shown in FIG. 6.

As shown in FIG. 8, the cleaning unit 17 may include the powder case 51, the cleaning blade 33, the resin film 34, and the drive gear 60.

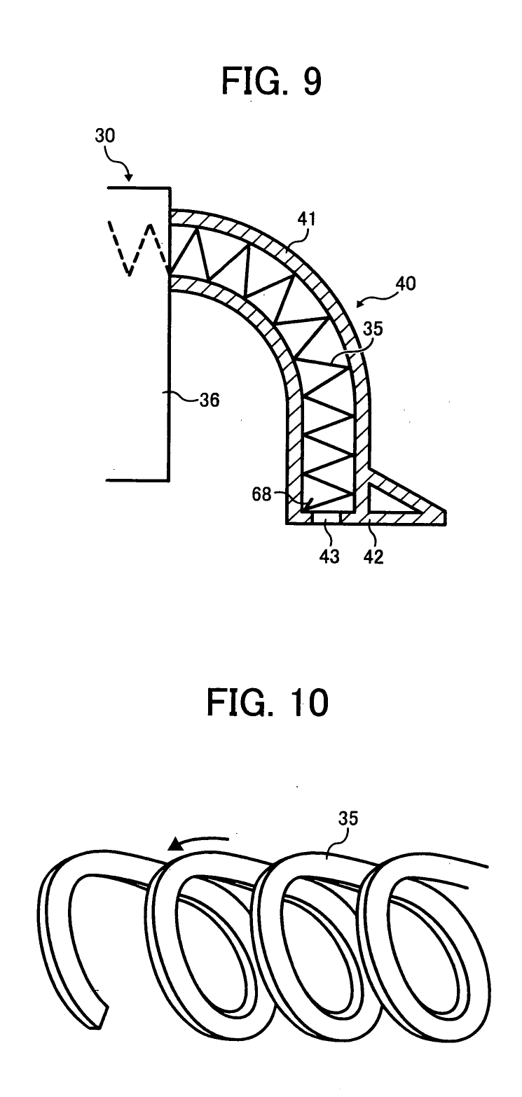

As shown in FIG. 8, the powder transport unit 40 is attached to the cleaning unit 17, and includes a transport pipe 41, in which the powder transport coil 35 can be inserted in the transport pipe 41 (see FIG. 9).

The transport pipe 41 can be made of material such as polypropylene (PP), for example.

As shown in FIG. 8, the transport pipe 41 includes a regulating member 42 and an exit hole 43 in the regulating member 42, wherein the regulating member 42 may have a rectangular-shaped form (see FIG. 8), for example.

As shown in FIG. 8, the regulating member 42 can be formed integrally with the transport pipe 41 with a same material.

Accordingly, the transport pipe 41 including the regulating member 42 can be made of a material such as polypropylene, which has a relatively lower cost and a higher anti-abrasion property.

Therefore, the transport pipe 41 can be made with a relatively lower cost and can suppress an abrasion by frictional effect by the power transport coil 35, by which the transport pipe 41 can enhance its lifetime.

FIG. 9 is a cross-sectional view of the powder transport unit 40.

As shown in FIG. 9, the transport pipe 41 is connected to the first plate 36 of the process cartridge 30, and is curvingly extended to a downward direction.

As shown in FIG. 9, the regulating member 42 having the exit hole 43 is provided at an end portion of the transport pipe 41.

As shown in FIG. 9, the powder transport coil 35 for transporting powders (e.g., toner particles) can be inserted in the transport pipe 41. The powder transport coil 35 extends to the regulating member 42 of the transport pipe 41.

As shown in FIG. 10, the powder transport coil 35 can be formed in a helical coil made of long and thin plate, and a free edge of the powder transport coil 35 can be contacted to the regulating member 42.

In general, a helical coil, such as a powder transport coil 35, has a cross-sectional area formed in a rectangular shape. The helical coil has a lower rigidity compared to a helical coil having a cross-section area formed in a circular shape. Accordingly, the helical coil having a lower rigidity can elongate and contract with a smaller force.

Therefore, the powder transport coil 35 can be easily deflexed (e.g., elongate and contract) with a smaller force, and can be easily retained by the regulating member 42.

In an example shown in FIG. 10, the powder transport coil 35 can be elongated and contracted in its entire length. However, the powder transport coil 35 can be formed so that the powder transport coil 35 elongates and contracts at one portion of the powder transport coil 35.

Furthermore, the powder transport coil 35 may have an outer diameter, which is set larger than a diameter of the exit hole 43 so that the free edge side of the powder transport coil 35 can be abutted to the regulating member 42 more securely.

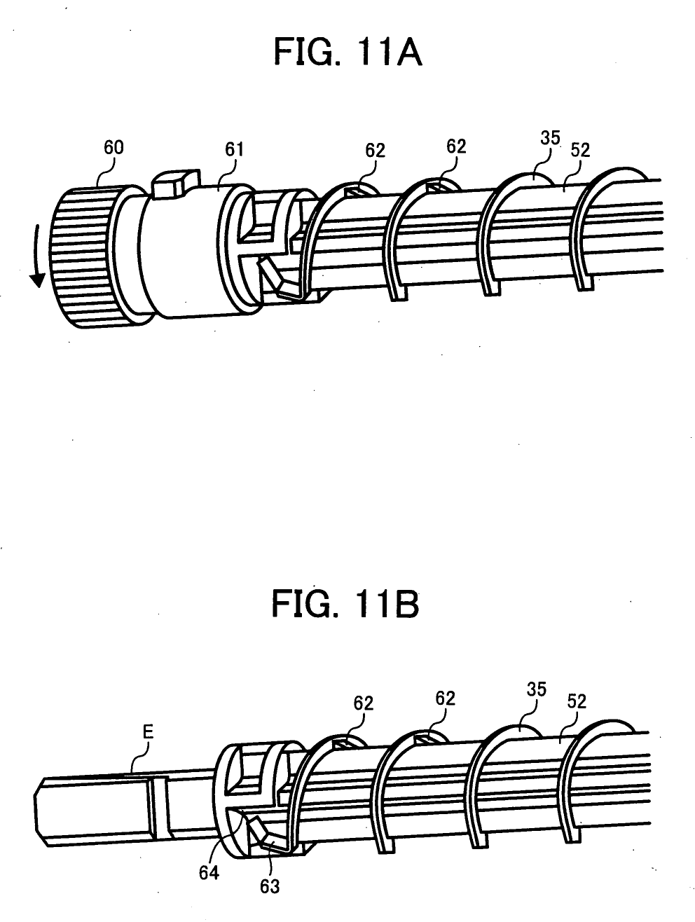

FIGS. 11A and 11B are expanded views of the shaft 52 wound with the powder transport coil 35, wherein the FIGS. 11A and 11B show a portion close to the second plate 37 of the process cartridge 30.

The shaft 52 can be made of resin material, and may have a cross-sectional shape of cross-like figure when viewed from an axial direction of the shaft 52.

As shown in FIG. 11B, the shaft 52 has a protruded portion E. Although not shown in FIG. 11B, the protruded portion E has a cross-section area in a letter “D” shape, for example.

As shown in FIG. 11A, a bearing 61 can be inserted along the protruded portion E, and then attached and fixed to the shaft 52.

The shaft 52 and powder transport coil 35 can be set in a given position in the powder container 51 by placing the bearing 61 in a given position in the cleaning unit 17.

Hereinafter, the powder transport coil 35 and the shaft 52 are explained.

If the powder transport coil 35 is provided in the powder container 51 without the shaft 52, a hollow portion may exist in a center of the powder transport coil 35.

Under such a condition, toner particles may accumulate and aggregate in the hollow center portion of the powder transport coil 35.

Specifically, toner particles may aggregate as a toner block in the transport pipe 41. Under such a condition, the closer to a downstream of the transport pipe 41, the larger the aggregation degree of toner blocks. Accordingly, the transport pipe 41 may be clogged by such aggregation.

Furthermore, as for an image forming apparatus which recycles or reuses toner particles, aggregated toner particles returned to the developing unit 14 can not be used as it is in the developing unit 14 because of such aggregation of toner particles. In such a condition, a process of pulverizing the aggregated toner particles and a process of selecting sizes of toner particles may be required.

In an example embodiment, the shaft 52 having a cross-sectional shape of a cross-like figure, when viewed from the axial direction of the shaft 52, is employed, for example.

Under such a configuration, the shaft 52 can function as an impeller, which repels toner particles which may accumulate in the hollow center portion of the powder transport coil 35.

With such a repelling effect by the shaft 52, toner particles can be transported with the powder transport coil 35 while suppressing an aggregation of toner particles along the powder transport coil 35.

In an example embodiment, the transport pipe 41 of the powder transport unit 40 has a curved shape, and the powder transport coil 35 can be inserted in the transport pipe 41 as shown in FIG. 9.

The transport pipe 41 may be formed in a curved shape to enhance a miniaturization of the image forming apparatus 100 as a whole.

The powder transport coil 35 has spring elasticity in a longitudinal direction and radial direction of the powder transport coil 35.

Therefore, when the powder transport coil 35 is inserted in transport pipe 41 having a curved-shape, the powder transport coil 35 may bend (or curved) along an inner surface of the transport pipe 41.

Under such a condition, the powder transport coil 35 having resilience may try to return to a straight shaped condition (i.e., original shape) from a bended (or curved) condition. Then, the outer face of the powder transport coil 35 may be pushed toward the inner surface of the transport pipe 41 having a curved portion.

When toner particles are transported through the transport pipe 41 having a curved portion under such a condition, toner particles may be pressed toward the inner surface of the curved transport pipe 41 with a relatively larger force.

Accordingly, toner particles may be more likely to aggregate in the transport pipe 41 having a curved portion compared to a transport pipe having a straight shape.

In an example embodiment, the shaft 52 having a cross-sectional shape of a cross-like figure is wound with the powder transport coil 35 as above described.

Under such a configuration, the shaft 52 can function as an impeller, which repels toner particles to a radially outward direction of the powder transport coil 35, by which toner particles can be transported by the powder transport coil 35 while suppressing an aggregation of toner particles at an upstream of the powder transport coil 35.

If the shaft 52 is not provided, toner particles may accumulate in the hollow center portion of the powder transport coil 35 because toner particles in the hollow center portion may receive little force.

If such accumulated toner particles are transported to the transport pipe 41 having a curved portion, such toner particles may stick together and block the transport pipe 41.

By providing the shaft 52 in the upstream of the powder transport coil 35, an aggregation of toner particles at the upstream of the powder transport coil 35 can be suppressed with a repelling effect of the shaft 52.

Therefore, toner particles having less aggregation can be transported from upstream of the powder transport coil 35 to downstream of the powder transport coil 35, wherein the downstream of the powder transport coil 35 may correspond to an inner path of the transport pipe 41.

Although the transport pipe 41 has a curved portion as mentioned above, at which toner particles are likely to aggregate, toner particles transported in the transport pipe 41 may be less likely to aggregate because the toner particles transported from upstream of the powder transport coil 35 have less aggregation.

Accordingly, an aggregation or blocking of toner particles in the powder container 51 and transport pipe 41 can be effectively suppressed from the upstream to downstream of the powder transport coil 35.

Although not shown in FIG. 11A, the drive gear 60 has a cavity in a letter “D” shape, for example.

Therefore, as shown in FIG. 11A, the drive gear 60 can be fixed to the shaft 52 by engaging the protruded portion E of the shaft 52 into the “D” letter-shaped cavity of the drive gear 60.

When the second idler gear (not shown) transmits a rotation to the drive gear 60, the drive gear 60 transmits a rotation to the shaft 52, by which the shaft 52 and the powder transport coil 35 are rotated. Toner particles can be transported in the powder container 51 in a direction from the second plate 37 to the first plate 36 of the process cartridge 30.

The powder transport coil 35 can be made of a material, such as stainless steel plate, for example.

Specifically, the powder transport coil 35 can be made of stainless steel plate, which is formed into a helical coil that can elongate and contract in a longitudinal direction.

The powder transport coil 35 has an inner diameter, which is set slightly larger than a diameter of the shaft 52. The powder transport coil 35 can be inserted on the shaft 52 as below.

In FIG. 11A, the powder transport coil 35 can be inserted onto the shaft 52 from a right to left direction.

When the powder transport coil 35 is almost inserted on the shaft 52, the powder transport coil 35 contacts two claws 62 on the shaft 52, and the powder transport coil 35 can be moved onto a slope of the two claws 62 by deflexing the powder transport coil 35.

When the powder transport coil 35 passes over the two claws 62 on the shaft 52, the powder transport coil 35 can be positioned on the shaft 52 with the two claws 62.

Then, the powder transport coil 35 is engaged to the shaft 52 by hooking an edge 63 of the powder transport coil 35 to a receiver 64 of the shaft 52 shown in FIG. 11B, wherein the edge 63 is bended for some degree.

With such a process, the powder transport coil 35 can be fixed on the shaft 52.

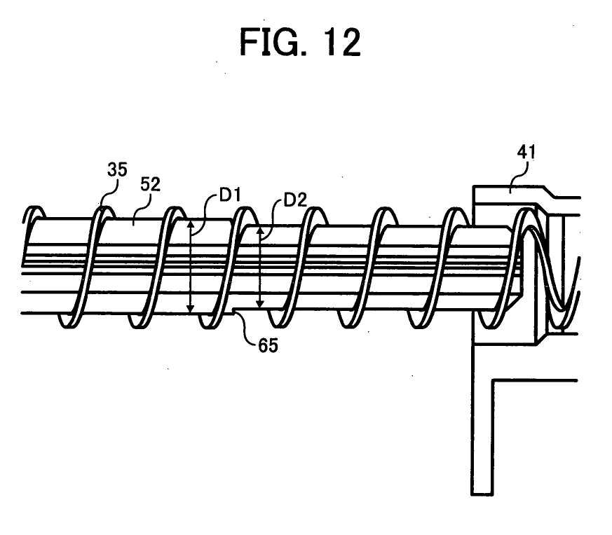

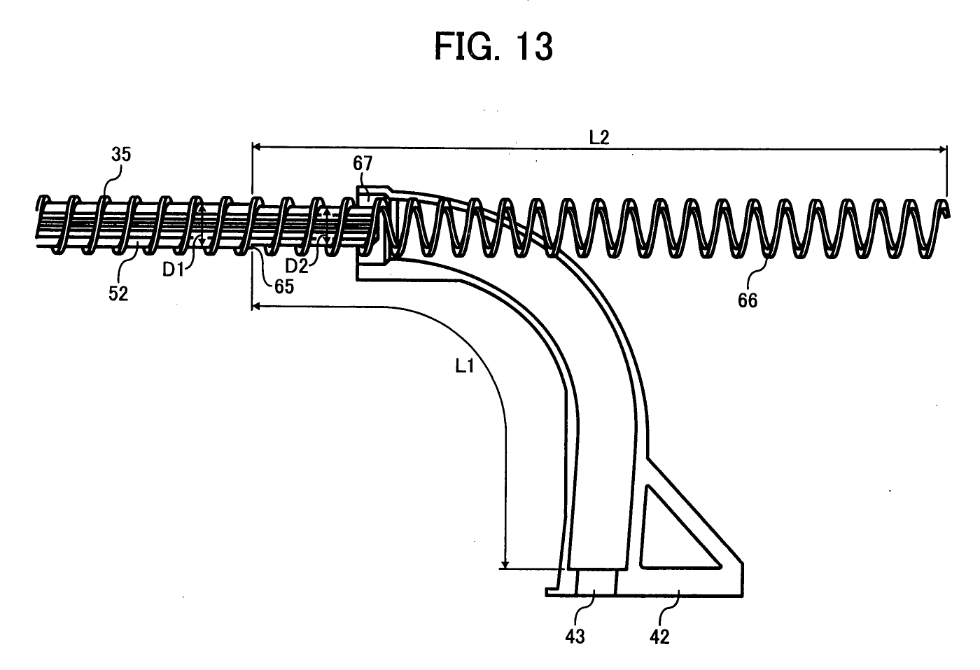

FIG. 12 is a schematic side view of the shaft 52 wound with the powder transport coil 35.

As shown in FIG. 12, the shaft 52 includes a step 65 on a face of the shaft 52, by which the shaft 52 has two diameters of D1 and D2. The diameter D1 is set slightly larger than the diameter D2.

Accordingly, the powder transport coil 35 has two inner diameters, which can correspond to the diameters of D1 and D2 of the shaft 52.

FIG. 13 is a schematic side view of the shaft 52 and powder transport coil 35, in which a distance L1 is a length between the step 65 on the shaft 52 and the regulating member 42. A natural length L2 is a length for a smaller diameter portion 66 of the powder transport coil 35, which has a smaller inner diameter for the powder transport coil 35.

The smaller diameter portion 66 may have the natural length of L2 when the smaller diameter portion 66 is not elongated or contracted.

If the distance L1 and the natural length L2 have a relationship of “L1<L2 (including tolerance of length),” a free edge of the powder transport coil 35 can be constantly contacted and pressed to the regulating member 42.

The smaller diameter portion 66 of the powder transport coil 35 may have a smaller pitch so that the smaller diameter portion 66 can be inserted in the curved portion of the transport pipe 41 with a smaller force.

Although the powder transport coil 35 can be designed to have a smaller pitch on its entire length, such configuration may not be preferable from a viewpoint of manufacturing cost of the powder transport coil 35.

Hereinafter, a spring property of the powder transport coil 35 is explained.

In general, a spring constant of the powder transport coil 35 can be set to a smaller value to facilitate an insertion of the powder transport coil 35 in the transport pipe 41 having a curved shape and a stopping of the powder transport coil 35 at the regulating member 42.

When the spring constant is set to a smaller value, an elastic force in a longitudinal direction of the powder transport coil 35 can become smaller.

If such elastic force becomes a smaller value, the powder transport coil 35 can be elongated or contracted with a smaller force.

Specifically, the spring constant can be set to a smaller value by increasing a winding number of the coils, or reducing a diameter of the coils (e.g., plate thickness of helical coil), for example.

When a load stress for transporting toner particles in the transport pipe 41 becomes greater while using the powder transport coil 35 having a smaller spring constant, the free edge of the powder transport coil 35, which is pressed to the regulating member 42, may be easily moved toward an upstream side of the powder transport coil 35 (i.e., may be easily moved away from the regulating member 42).

Such load stress for transporting toner particles may become greater when a larger amount of toner particles are transported or when an aggregation level of toner particles becomes greater, for example.

If the load stress becomes greater, a larger force is required for transporting toner particles by the powder transport coil 35.

If the step 65 is not provided for the powder transport coil 35 and the powder transport coil 35 has no smaller diameter portion 66, an entire length of powder transport coil 35 may contract due to the above-mentioned load stress. Thereby the free edge of the powder transport coil 35 may be moved away from the regulating member 42.

For example, if the powder transport coil 35 has a total length of 400 mm, and the powder transport coil 35 may contract 4 mm, such contraction becomes a 1% contraction of the total length of 400 mm because the entire length of the powder transport coil 35 is contracted.

In such a condition, a larger repulsion force may not be generated in the powder transport coil 35, therefore, the powder transport coil 35 may deflex significantly with a smaller load stress.

On one hand, if the powder transport coil 35 has a total length of 400 mm and includes an 80 mm length between the step 65 on the powder transport coil 35 and the free edge of the powder transport coil 35, the powder transport coil 35 may contract at the 80 mm length portion. In other words, the powder transport coil 35 may not contract in its entire length but contract only on the 80 mm length portion.

In such a case, a contraction of 4 mm of the powder transport coil 35 becomes a 5% of 80 mm length (i.e., 5/80 mm=0.05). In other words, such contraction becomes a 5%-contraction of the 80 mm length portion because the powder transport coil 35 is contracted only on the 80 mm length portion.

When comparing 1%-contraction and 5%-contraction, a larger repulsion force is required for 5%-contraction. Specifically, a force required for 5%-contraction is about five times of force required for 1%-contraction.

Therefore, the smaller the contraction, the smaller the force required for contraction. Furthermore, if a force required for contraction becomes smaller, a repulsion force of the powder transport coil 35 becomes correspondingly smaller.

In an example embodiment, the shaft 52 has the step 65, and the powder transport coil 35 has the smaller diameter portion 66 having a smaller inner diameter.

With such a configuration, the smaller diameter portion 66 of the powder transport coil 35 is abutted to the step 65, and only a part (i.e., a natural length L2 in FIG. 13) of the powder transport coil 35 may contract with a load stress, which may be effected between the smaller diameter portion 66 and the step 65.

With such a configuration, a repulsion force can be made greater for the powder transport coil 35, by which the free edge of the powder transport coil 35 may not be easily moved away from the regulating member 42.

Hereinafter, a boundary portion between the cleaning unit 17 and powder transport unit 40 is explained.

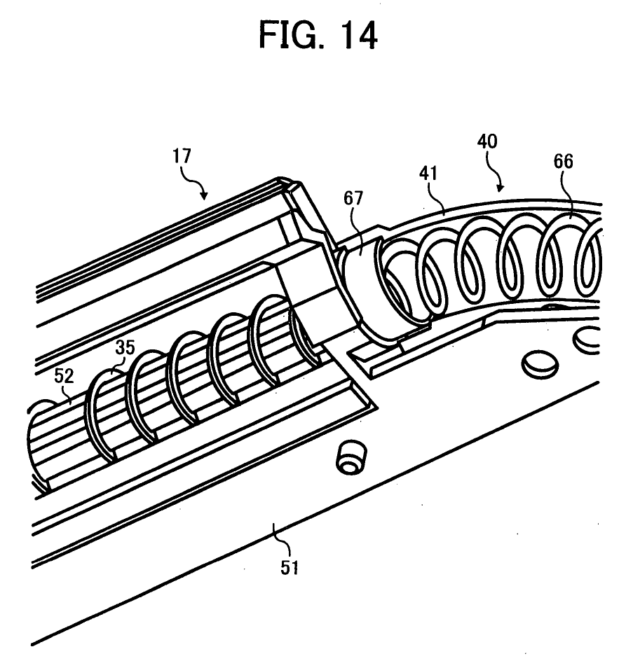

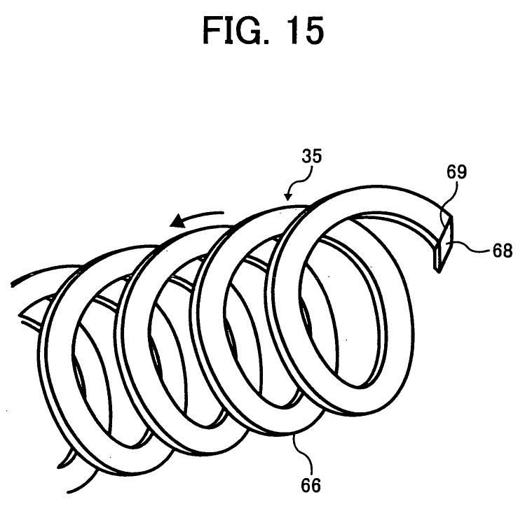

FIG. 14 is an expanded view of a boundary portion between the cleaning unit 17 and powder transport unit 40.

As shown in FIG. 14, the transport pipe 41 of the powder transport unit 40 includes a ring 67 fitted at a boundary portion between the cleaning unit 17 and transport pipe 41.

The ring 67 has an inner diameter, which is set slightly larger than an outer diameter of the smaller diameter portion 66 of the powder transport coil 35.

The shaft 52 wound with the powder transport coil 35 may be inserted in the ring 67.

A downstream portion of the powder transport coil 35 is curved because the powder transport coil 35 is inserted in the transport pipe 41 having a curved shape.

Accordingly, the downstream portion of the powder transport coil 35 may be more likely to vibrate when the powder transport coil 35 is rotated.

Therefore, the shaft 52 wound with the powder transport coil 35 may be inserted in the ring 67 so that the downstream of the powder transport coil 35 can be securely supported with the shaft 52 and the powder transport coil 35 at the ring 67.

The shaft 52 may be extended and inserted in a part of the ring 67, and may be extended and inserted in an entire length of the ring 67.

With such a configuration, the downstream of the powder transport coil 35 having no shaft can be supported at the ring 67 more securely.

The downstream of the powder transport coil 35, passed through the ring 67, is curved along the inner face of the transport pipe 41 because the downstream of the powder transport coil 35 has no shaft.

The outer diameter of the smaller diameter portion 66 is set slightly smaller than the inner diameter of the transport pipe 41.

FIG. 15 is an expanded view of a free edge 68 of the powder transport coil 35. The powder transport coil 35 can contact with the regulating member 42 with the free edge 68 of the powder transport coil 35.

As shown in FIGS. 9 and 15, the free edge 68 of the powder transport coil 35 is bent in an inward direction, wherein the inward direction is a direction opposite to the regulating member 42.

Specifically, as shown in FIG. 9, the free edge 68 is bent in a direction, which is an opposite direction from the regulating member 42.

With providing the free edge 68, the free edge 68 may be pressed to an inner face of the regulating member 42 at a bending line 69 when the powder transport coil 35 is inserted in the transport pipe 41 and regulated by the regulating member 42.

With such a configuration, the free edge 68 of the powder transport coil 35 may not be hooked to the regulating member 42.

In general, a free edge of a coil has a sharp profile because a coil is made by cutting a wire or the like. If such a sharp profile contacts the regulating member 42, the sharp profile may cause damage, such as scratches on the regulating member 42. Such damage may degrade a sliding rotation efficiency of the powder transport coil 35 at the regulating member 42, which may affect an overall efficiency of the powder transport coil 35.

Therefore, in an example embodiment, the powder transport coil 35 has the free edge 68 bent in the inward direction to reduce the likelihood or prevent such damages.

Furthermore, the free edge 68 can be bent in a direction, which is opposite to a rotational direction of the powder transport coil 35 so that the regulating member 42 may not hook the free edge 68.

In an example embodiment, the image forming apparatus 100 employs a tandem type arrangement for forming color image. However, other types of arrangement, such as revolver type (or rotary type), can be similarly used in the image forming apparatus 100 for forming color image.

Furthermore, the above-described example embodiment can be similarly used for an image forming apparatus for forming monochrome image.

Furthermore, the above-described powder transport unit and process cartridge according to an example embodiment can be used for any types of image forming apparatus.

In an example embodiment, a toner image formed on a photosensitive member is first transferred to an intermediate transfer belt, and then the toner image transferred on a recoding medium. However, a toner image formed on a photosensitive member can be directly transferred on a recoding medium in an example embodiment.

The above-described example embodiment is applied to transport toner particles in the primary cleaning unit. However, the above-described example embodiment can also be applied to transport toner particles in the secondary cleaning unit, which removes toner particles remaining on the intermediate transfer belt.

In the above-described example embodiment, the powder transport coil 35 has the natural length L2 under a condition of no load, wherein the natural length L2 is set larger than a length of the transport pipe 41.

As above described, the powder transport coil 35 can be inserted in the transport pipe 41 and abutted to the regulating member 42 provided at an end of the transport pipe 41.

Therefore, even if some length variation may occur to the powder transport coil 35 during manufacturing process, the powder transport coil 35 can be extended in an entire length of the transport pipe 41, by which powder transportability by the powder transport coil 35 in the transport pipe 41 can be secured. Thereby a clogging of transport pipe 41, such as toner particle clogging, can be reduced or prevented.

Furthermore, even if some length variation may occur to the powder transport coil 35 during manufacturing process, the powder transport coil 35 may not protrude from the transport pipe 41 because the regulating member 42 provided at an end of the transport pipe 41 can regulate a length of the powder transport coil 35. Accordingly, the powder transport coil 35 may not interfere with other parts, such as powder transport member, waste toner tank, and shutter, which may be attached to the exit hole 43 of the transport pipe 41.

Furthermore, with such a configuration, the transport pipe 41 and the regulating member 42 can be integrally formed. Accordingly, a separate part is not required for the regulating member 42, by which a number of parts can be reduced, and then a number of assembly work steps can be also reduced.

As above explained, the transport pipe 41 having a curved shape is attached and protruded from the powder container 51 as shown in FIG. 8.

The process cartridge 30 can be removed from the image forming apparatus 100 when conducting maintenance work for the process cartridge 30.

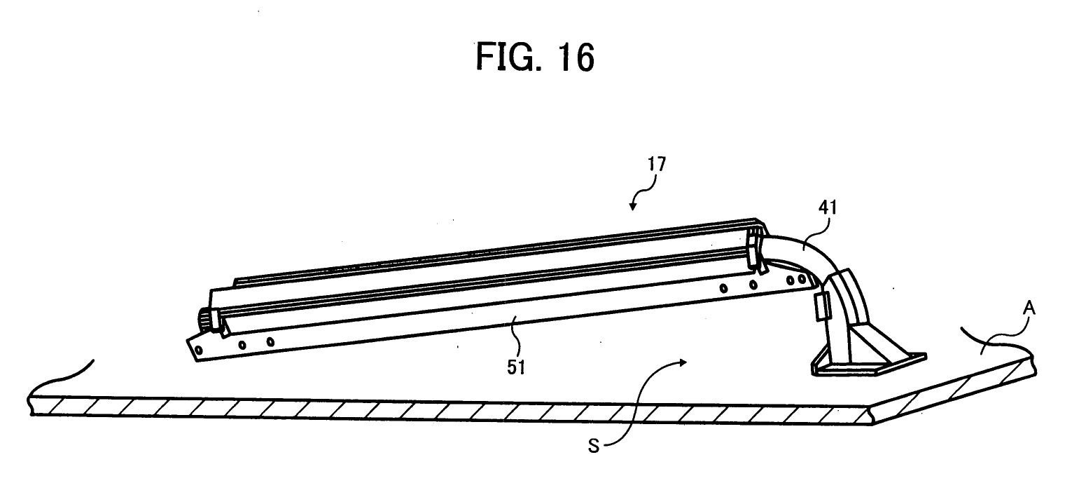

In such maintenance work, the cleaning unit 17 may be removed from the process cartridge 30, and the powder container 51 can be placed on a plane A, such as a floor face and table face, while contacting the regulating member 42 of the transport pipe 41 on the plane A as shown in FIG. 16.

FIG. 16 shows the cleaning unit 17 placed on the plane A. As shown in FIG. 16, the powder container 51 and the plane A may have a space S therebetween because the transport pipe 41 having a curved shape can be stood on the plane A.

With a configuration shown in FIG. 9, the powder transport coil 35 are inserted in an entire length of the transport pipe 41, by which toner particles can be effectively transported in the transport pipe 41 without clogging of toner in the transport pipe 41. Accordingly, toner particles may not substantially remain in the transport pipe 41.

Therefore, toner particles may not substantially spill from the transport pipe 41 when the transport pipe 41 is stood on the plane A.

Accordingly, the plane A may not be substantially stained by toner particles.

Under a condition shown in FIG. 16, the exit hole 43 of the transport pipe 41 can contact the plane A, by which a user may not touch on the exit hole 43 during a maintenance work, and thereby the user may be free from stain on user's hand or cloth during the maintenance work.

Furthermore, under a condition shown in FIG. 16, the powder container 51 can be placed on the plane A while securing the space S between the powder container 51 and the plane A by standing the transport pipe 41 having a curved shape on the plane A.

Accordingly, a user can easily pick up the cleaning unit 17 placed on the plane A (e.g., floor face) by holding the transport pipe 41, for example, by which the user can conduct a maintenance work more easily and efficiently.

Therefore, the powder transport unit according to the above-described example embodiment can be made with a relatively lower cost, can reduce the likelihood or prevent a stain on user's hand or cloth during a maintenance work, and can effectively enhance maintenance-ability.

Numerous additional modifications and variations are possible in light of the above teachings. It is therefore to be understood that within the scope of the appended claims, the disclosure of the present invention may be practiced otherwise than as specifically described herein.

What is claimed is:

1. A powder transport unit for use with a process cartridge for transporting powders, comprising:
a transport pipe configured to be curvingly extended;
a powder transport member, disposed in an entire length of the transport pipe and configured to rotate in the transport pipe to transport the powders; and
a regulating member, integrally formed with the transport pipe at a downstream end of the transport pipe, configured to regulate a length of the powder transport member disposed in the entire length of the transport pipe, and having an exit hole configured to pass therethrough the powders transported by the powder transport member in the transport pipe.

2. The powder transport unit according to claim 1, wherein the transport pipe and the regulating member are integrally made of polypropylene.

3. The powder transport unit according to claim 1, wherein the powder transport member includes a helical coil made of a plate material.

4. The powder transport unit according to claim 3, wherein the powder transport member elongates and contracts in a longitudinal direction of the powder transport member, and the powder transport member has a free edge contactingly pressed to the regulating member when the powder transport member is disposed in the entire length of the transport pipe and regulated by the regulating member.

5. The powder transport unit according to claim 4, wherein the free edge of the powder transport member is bended in a direction substantially opposite to the regulating member.

6. The powder transport unit according to claim 1, wherein the exit hole of the regulating member has a circular shape and includes a diameter smaller than an outer diameter of the powder transport member.

7. The powder transport unit according to claim 1, wherein the process cartridge includes a photosensitive member configured to form a latent image thereon to be developed as toner image by toner particles and a cleaning unit configured to remove toner particles from the photosensitive member, wherein the cleaning unit includes a powder container for collecting the removed toner particles, and the powder container is connected to the transport pipe.

8. The powder transport unit according to claim 7, wherein the powder transport member extends from the powder container to the regulating member of the transport pipe.

9. The powder transport unit according to claim 7, wherein the powder container of the cleaning unit is place-able on a plane while securing a space between the powder container and the plane by standing the regulating member of the transport pipe on the plane.

10. The powder transport unit according to claim 7, wherein the powder transport member existing in the powder container is wound on a shaft.

11. The powder transport unit according to claim 10, wherein the shaft has a step on a circumferential surface of the shaft to provide a first outer diameter portion and a second outer diameter portion to the shaft, wherein the first diameter is set larger than the second diameter, and the powder transport member has a first inner diameter portion and a second inner diameter portion fitable on the first outer diameter portion and the second outer diameter portion of the shaft, respectively.

12. The powder transport unit according to claim 11, wherein the second inner diameter portion of the powder transport member extends from the step on the shaft to the free edge of the powder transport member, and the second inner diameter portion of the powder transport member has a natural length which is set larger than a length between the step on the shaft and the regulating member of the transport pipe.

13. A process cartridge for use in an image forming apparatus, comprising:
a photosensitive member configured to form a latent image thereon to be developed as toner image by toner particles;
a cleaning unit configured to remove the toner particles remaining on the photosensitive member, the cleaning unit comprising:
a powder container configured to collect the toner particles removed from the photosensitive member; and
a powder transport unit configured to transport the removed toner particles, the powder transport unit comprising:
a transport pipe configured to be curvingly extended and connected to the powder container;
a powder transport member, disposed in an entire length of the transport pipe and the powder container, configured to rotate in the transport pipe and the powder container to transport the removed toner particles; and
a regulating member, integrally formed with the transport pipe at a downstream end of the transport pipe, configured to regulate a length of the powder transport member disposed in the entire length of the transport pipe, and having an exit hole configured to pass therethrough the removed toner particles transported by the powder transport member in the transport pipe.

14. An image forming apparatus, comprising:
a photosensitive member configured to form a latent image thereon to be developed as toner image by toner particles;
a cleaning unit configured to remove the toner particles remaining on the photosensitive member, the cleaning unit comprising:
a powder container configured to collect the toner particles removed from the photosensitive member; and
a powder transport unit configured to transport the removed toner particles, the powder transport unit comprising:
a transport pipe configured to be curvingly extended and connected to the powder container;
a powder transport member, disposed in an entire length of the transport pipe and the powder container, configured to rotate in the transport pipe and the powder container to transport the removed toner particles; and
a regulating member, integrally formed with the transport pipe at a downstream end of the transport pipe, configured to regulate a length of the powder transport member disposed in the entire length of the transport pipe, and having an exit hole configured to pass therethrough the removed toner particles transported by the powder transport member in the transport pipe.
